(19) United States
(12) Patent Application Publication
(10) Pub. No.: US 2008/0022218 A1
(43) Pub. Date: Jan. 24, 2008

(54) Method for cache image display

(75) Inventor: Dong-Qiang Cai, Hangzhou City (CN)

Correspondence Address: BACON & THOMAS, PLLC, 625 SLATERS LANE, FOURTH FLOOR, ALEXANDRIA, VA, 22314, US

(73) Assignee: ArcSoft, Inc., Fremont, CA (US)

(21) Appl. No.: 11/491,286

(22) Filed: Jul. 24, 2006

(51) Int. Cl. G06F 9/00

(52) U.S. Cl. 715/769; 715/838; 715/835; 715/815

(57) ABSTRACT

A method for cache image display in an electronic apparatus having at least a LCD screen and a storage device, said method being applied when a user performs operations such as shrinking, enlarging, dragging or adjusting the viewing area of a thumbnail image on said screen, said method comprises the steps of determining if a random access memory in said electronics apparatus contains a pre-shrunk cache image and said pre-shrunk image has nearly the same image size as the one demanded by said user; retrieving said cache image upon the determination that said pre-shrunk cache image has nearly the same image size as the one demanded by said user; resizing said cache image with a proper proportion to form a new thumbnail image with the size demanded by said user; and displaying said thumbnail image on said LCD screen.

### FIELD OF THE INVENTION

The present invention relates to a method for cache display. More particularly, the present invention relates to a method for cache image display in an apparatus having a LCD screen and a method which user does not perceive a visual delay when a new thumbnail image is generated and displayed on the screen.

### BACKGROUND OF THE INVENTION

Portable digital electronic apparatus (e.g. MP3 players, Personal Digital Assistants and cellular phones) have become increasingly popular in recent years with their progress in display quality, more compact physical sizes and lower retail prices. Take photo-capturing cellular phones as an example, in addition to having Charge-Coupled Device (CCD) image sensors or CMOS image pick-up elements for capturing pictures, they also posses a small size Liquid Crystal Display (LCD) screen for users to view the photos. The photos taken are usually stored in an inserted memory card after they are taken. When a user selects a photo on the cellular phone, the cellular phone retrieves the demanded image from said memory card, re-decodes then displays a shrunk-image (thumbnail image) of said demanded image on said screen. The user can therefore shrinks, enlarges, drags or adjusts the viewing area of said image on said screen.

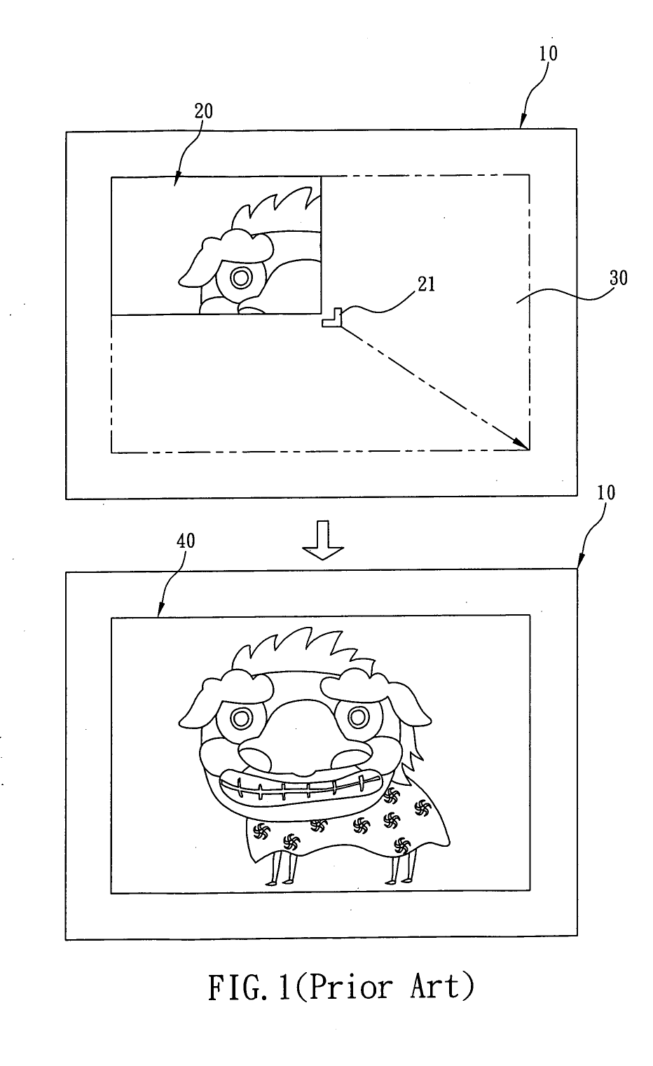

Traditionally, regardless of the size of the images stored in the electronic device (e.g. 1.2 Mega Bytes or 120K bytes), said images are first stored in a storage device of said electronic apparatus (e.g. a memory card, a hard drive or a USB drive). When a user selects a particular image to view, said electronic apparatus retrieves said image from said storage device, re-encodes and shrinks the original image to a thumbnail image of a few tens of thousand K bytes (e.g. 75 K bytes) and then displays said thumbnail image on its small size LCD screen for the user to browse and perform operations such as shrinking, enlarging, dragging or adjusting the viewing area on said thumbnail image. Refer to FIG. 1. To perform an adjustment of the viewing area of a thumbnail image 20 on a LCD screen of an aforementioned traditional electronic apparatus, a user selects and moves a control cursor 21 of said thumbnail image 20 along the dotted-line in the direction of the arrow to expand the viewing area of said thumbnail image 20. According to this instruction given by the user, said electronic apparatus retrieves the original image from a storage device, re-encodes said original image so that said original image is shrunk to the demanded size, then crops the desired viewing area and displays a new thumbnail image 40 on the LCD screen 10. Since in said traditional method, it takes a substantial amount of time (up to a few seconds) for said electronic apparatus the retrieve the original image from said storage device and then encode said image, the display of the expanded area 30 on the LCD screen 10 will be delayed. In other words, there will be a period of time before the completion of the viewing area adjustment on said thumbnail image 20 in which the new thumbnail image 40 can not be displayed on said screen. This display delay will prevent the user to determine whether the adjustment made is satisfactory, causing inconvenience and ineffectiveness in the operations.

### SUMMARY OF THE INVENTION

After considerable research and experimentation, a method for cache image display according to the present invention has been developed so as to overcome the drawbacks associated with said traditional method. A user can perform operations such as shrinking, enlarging, dragging or adjusting the viewing area of a thumbnail image on a LCD screen while obtain a real-time live-view display to determine immediately whether the operation made is satisfactory without incurring a delay in display and experiencing ineffectiveness in the operations.

It is an object of the present invention to provide a method for cache image display in an electronic apparatus. Said electronics apparatus retrieves an original image from a storage device then displays a thumbnail image of said original image while resizing said original image according to a pre-determined proportion (e.g. ½, ¼, ⅛, 1/16, etc.) To form a cache image and storing said cache image into a random access memory so that future operations performed on said thumbnail image can be more efficient by accessing said cache image.

It is another object of the present invention that when said thumbnail image displayed on said LCD screen is further shrunk, enlarged or viewing area adjusted, said electronics apparatus retrieves a pre-shrunk cache image which has nearly the same image size as the one demanded by said user and display said pre-shrunk cache image on the screen immediately to avoid display delay and enable the user to determine the status of the image after an operation is performed upon.

It is yet another object of the present invention that said electronics apparatus retrieves the encoded new thumbnail image and displays it on the screen after a user has completed operations of shrinking, enlarging dragging or viewing area adjusting so that the time spent on retrieving said original image from said storage device and encoding said original image will not be perceived by the user. Consequently, a visual delay is avoided when a new thumbnail image is generated and displayed.

The above and other objects, features and advantages of the present invention will become apparent from the following detailed description taken with the accompanying drawings.

### BRIEF DESCRIPTION OF THE DORIGINALINGS

FIG. 1 shows how a thumbnail image changes in a LCD screen of a traditional electronics apparatus when a viewing area adjustment operation is performed.

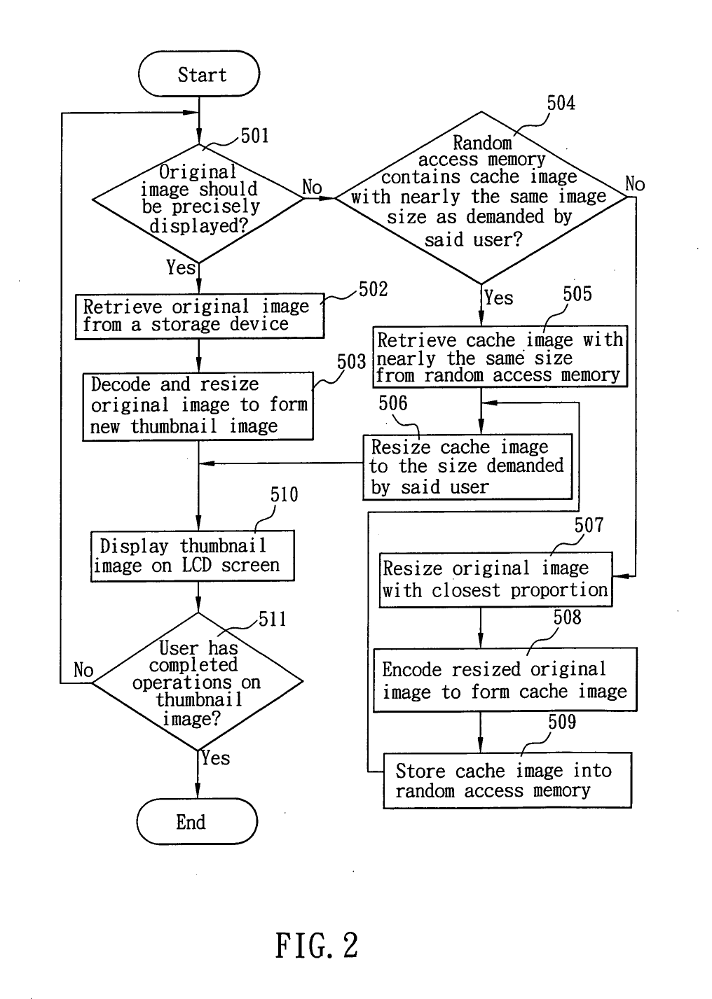

FIG. 2 shows a flow chart of the method for cache image display according to the present invention.

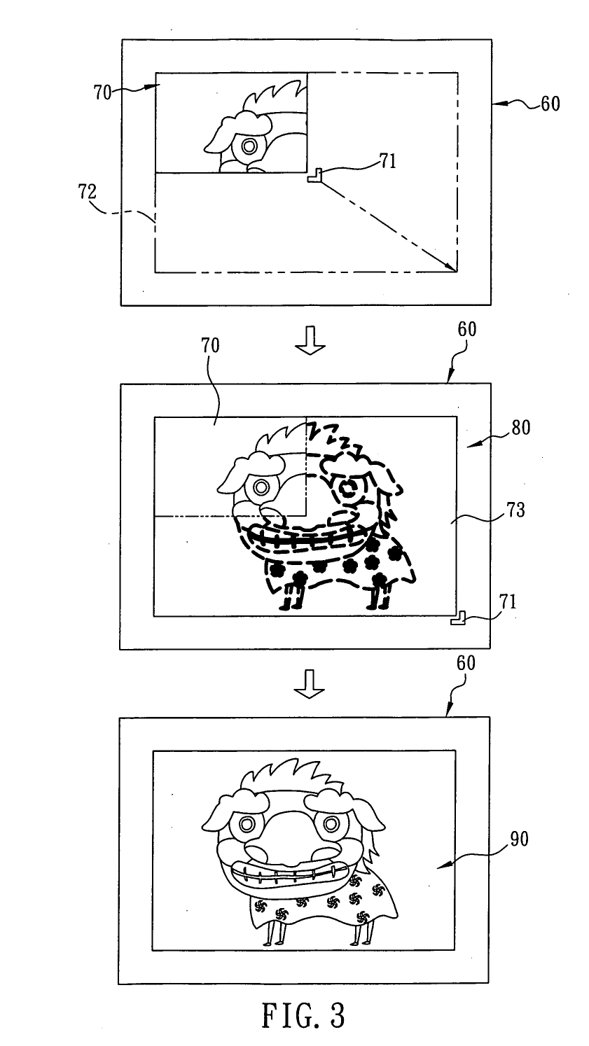

FIG. 3 shows in a preferred embodiment of the present invention, how a thumbnail image changes in an LCD screen of an electronics apparatus when a viewing area adjustment operation is performed.

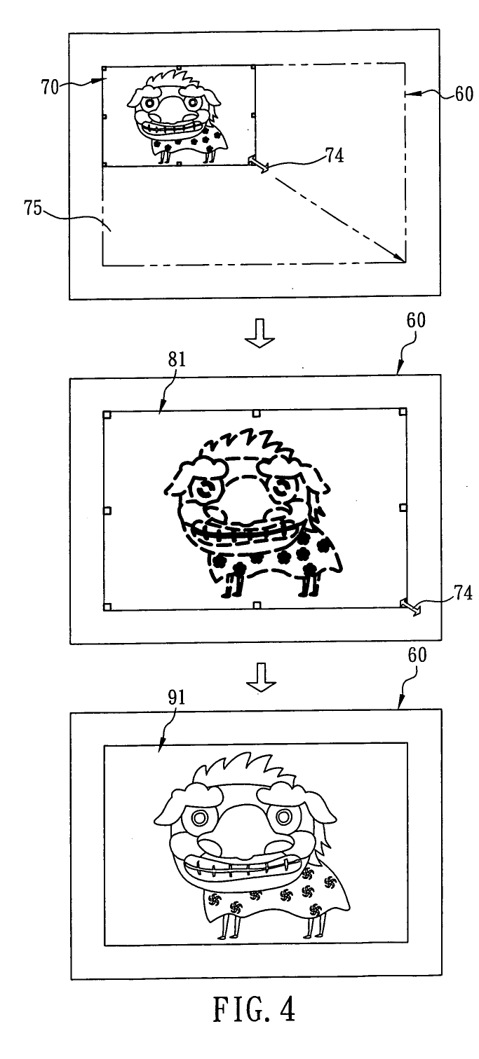

FIG. 4 shows in another preferred embodiment, how a thumbnail image changes in a LCD screen of an electronics apparatus when an enlargement operation performed.

### DETAILED DESCRIPTION OF THE PREFERRED EMBODIMENTS

The present invention is a method for cache image display in an electronic apparatus (e.g. a MP3 player, a Personal Digital Assistant or a cellular phone) having a LCD screen for displaying and viewing images and a storage device (e.g. a memory card, a hard drive or a USB drive) for storing images and data. Refer to FIG. 2. Said method is applied when a user performs operations such as shrinking, enlarging, dragging or adjusting the viewing area of a thumbnail image on said screen, and comprises the steps of:
(501) Determine from operations applied by said user whether an original image should be precisely displayed; if so, continue with the next step; otherwise go to step (504).
(502) According to user's instructions, retrieve said original image from a storage device.
(503) Decode said original image and resize said original image with a proper proportion to form a new thumbnail image with the size demanded by said user; go to step (510).
(504) Determine if a random access memory in said electronics apparatus contains a pre-shrunk cache image (e.g. in ratios of ¼, ⅛, 1/16 or 1/32, etc.) and said pre-shrunk image has nearly the same image size as the one demanded by said user; if so, go to the next step; otherwise go to step (507).
(505) Retrieve said cache image with nearly the same image size as the one demanded by said user from said random access memory.
(506) Resize said cache image with a proper proportion to form a new thumbnail image with the size demanded by said user; go to step (510).
(507) Resize an original image according to a pre-determined proportion (e.g. ¼, ⅛, 1/16 or 1/32, etc.) To a size near the one demanded by said user.
(508) Encode said resized original image to form a demanded cache image.
(509) Store said cache image into said random access memory; go to and perform step (506) simultaneously.
(510) Display said thumbnail image on said LCD screen.
(511) Determine if said user has completed operations on said thumbnail image displayed on said screen; if so, go to the next step; otherwise go to step (501).

The above-mentioned steps conclude that when a user performs operations such as shrinking, enlarging, dragging or adjusting the viewing area of a thumbnail image on a LCD screen, depending on the operations applied by said user, said electronics apparatus can retrieve the original image from said storage device and simultaneously, determine whether said random access memory in said electronics apparatus contains a pre-shrunk cache image which has nearly the same image size as the one demanded by said user. If it does, before displaying the thumbnail image demanded by said user, said electronics apparatus retrieves said cache image with nearly the same image size as the one demanded by said user and displays it on the LCD screen. After said user has completed operations of shrinking, enlarging, dragging or viewing area adjusting, said electronics apparatus then retrieves the original image from said storage device, decodes and adjusts said original image according to a pre-determined proportion to form a new thumbnail image and displays said new thumbnail image on said LCD screen. As a result, when the original thumbnail image is being shrunk, enlarged, dragged or viewing area adjusted, the time spent on retrieving the original image from said storage device and encoding said original image will not be perceived by said user. Consequently, a visual delay is avoided when a new thumbnail image is generated and displayed.

In the present invention, the number of cache images stored in said storage device can be designed according to the capacity of said random access memory and the size of the LCD screen. When the number of stored cache images reaches a pre-designed amount (e.g. ¼, ⅛, 1/16 and 1/32 four cache images), said electronic apparatus will not need to resize and encode the original image according to a pre-determined proportion to form a demanded cache image. This not only reduces the load in arithmetic computation for said electronic apparatus, but also increases the display speed of the images.

Refer to FIG. 3 for a preferred embodiment of the present invention. When performing an operation of viewing area adjusting on a thumbnail image 70 displayed on a LCD screen 60 of an electronic apparatus, a user selects a cursor 71 on said thumbnail image 70 and drags it along the dotted-line in the direction of the arrow to expand the viewing area of said thumbnail image 70. With the knowledge of the operations applied by said user, said electronic apparatus retrieves from a random access memory a cache image 72 which has the size nearest to the thumbnail image demanded by said user, extracts the viewing area 73 to be expanded from said cache image, combines it with the existing thumbnail image 70 to form an expanded image 80 and displays it on said LCD screen 60. Once said user completes the operation of adjusting the viewing area of said thumbnail image 70 and no longer selects said cursor 71, said electronic apparatus then retrieve an original image from said storage device, decodes and adjusts said original image according to a pre-determined proportion to form a new thumbnail image 90 and replaces said expanded image 80 with said new thumbnail image 90 on said screen. By implementing this method, while said user is adjusting the viewing area of said thumbnail image 70, said expanded image 80 is displayed on said LCD screen 60 first and immediately. Thus effectively shortens the display time and enables said user to view the perspective image of said thumbnail image 70 after the adjustments made, avoiding the time spent on retrieving said original image from said storage device and encoding said original image. Consequently, said user does not perceive a visual delay when said new thumbnail image 90 is being generated from said thumbnail image 70 and later displayed on said screen.

In another preferred embodiment as depicted in FIG. 4, a user is performing an operation of enlarging on a thumbnail image 70 displayed on a LCD screen 60 of an electronic apparatus by selecting a cursor 74 on said thumbnail image 70 and dragging it along the arrow on the dotted-line to increase the size of said thumbnail image 70. At this time, said electronic apparatus retrieves from a random access memory a cache image which has the size nearest to the enlarged image size 75 demanded by said user and immediately displays said cache image on said LCD screen 60 with the demanded enlarged image 81. Once said user completes the operation of enlarging said thumbnail image 70 and no longer selects said cursor 74, said electronic apparatus then retrieve an original image from said storage device, decodes and adjusts said original image according to said enlarged image size 75 to form a new thumbnail image 91 and replaces said enlarged image 81 with said new thumbnail image 91 on said screen 60. While said user is enlarging said thumbnail image 70, said enlarged image 81 with the demanded size 75 is displayed on said LCD screen 60 first and immediately. This effectively shortens the display time and enables said user to view the perspective image of said thumbnail image 70 after the enlargements made. Consequently, said user does not perceive a visual delay when said new thumbnail image 91 is being generated from said thumbnail image 70 and later displayed on said screen.

While the invention herein disclosed has been described by means of specific embodiments, numerous modifications and variations could be made thereto by those skilled in the art without departing from the scope and spirit of the invention set forth in the claims.

What is claimed is:

1. A method for cache image display in an electronic apparatus having at least a LCD screen and a storage device, said method being applied when a user performs operations such as shrinking, enlarging, dragging or adjusting the viewing area of a thumbnail image on said screen, said method comprises the steps of:
determining if a random access memory in said electronics apparatus contains a pre-shrunk cache image and said pre-shrunk image has nearly the same image size as the one demanded by said user;
retrieving said cache image upon the determination that said pre-shrunk cache image has nearly the same image size as the one demanded by said user;
decoding and resizing said cache image with a proper proportion to form a new thumbnail image with the size demanded by said user; and
displaying said thumbnail image on said LCD screen.

2. The method for cache image display of claim 1 further includes the steps of:
reading an original image corresponding to said thumbnail image from said storage device;
resizing, according to a pre-determined proportion, said original image to form a new thumbnail image; and
displaying said new thumbnail image on said LCD screen.

3. A method for cache image display in an electronic apparatus having at least a LCD screen and a storage device, said method being applied when a user performs operations such as shrinking, enlarging, dragging or adjusting the viewing area of a thumbnail image on said screen, said method comprises the steps of:
determining if a random access memory in said electronics apparatus contains a pre-shrunk cache image and said pre-shrunk image has nearly the same image size as the one demanded by said user;
resizing an original image according to a pre-determined proportion to a size near the one demanded by said user upon the determination that said pre-shrunk cache image does not have nearly the same image size as the one demanded by said user;
encoding said resized original image to form a demanded cache image;
storing said cache image into said random access memory; and
decoding and resizing said cache image with a proper proportion to form a new thumbnail image with the size demanded by said user and displaying said thumbnail image on said LCD screen.

4. The method for cache image display of claim 3 further includes the steps of:
reading an original image corresponding to said thumbnail image from said storage device;
encoding and adjusting according to a pre-determined proportion said original image to form a new thumbnail image; and
displaying said new thumbnail image on said LCD screen.
